(19) United States
(12) Patent Application Publication
(10) Pub. No.: US 2023/0162378 A1
(43) Pub. Date: May 25, 2023

(54) Virtual Camera Friendly Optical Tracking

(71) Applicant: Intel Corporation, Santa Clara, CA (US)

(72) Inventors: Chen Ling, Tianjin (CN); Wenlong Li, Beijing (CN); Qiang Li, Beijing (CN); Haihua Lin, Beijing (CN); Xiaofeng Tong, Beijing (CN)

(21) Appl. No.: 17/915,048

(22) PCT Filed: May 21, 2020
(86) PCT No.: PCT/CN2020/091490

§ 371 Date: Sep. 27, 2022

(51) Int. Cl. G06T 7/292; H04N 13/111

(52) U.S. Cl. CPC G06T 7/292; H04N 13/111; G06T 2207/30196; G06T 2207/30224; G06T 2207/30241

(57) ABSTRACT

A method for player and ball tracking post processing is described herein. The method includes optically tracking a trajectory of a player and ball and determining at least one affinity player for the currently tracked player. Additionally, the method includes completing the optical trajectory for the currently tracked player based on an estimated trajectory from the affinity player and stabilizing ball tracking during game break. The method further includes calculating virtual camera movement.

### BACKGROUND

Multiple cameras are used to capture activity in a scene. Subsequent processing of the captured images enables end users to view the scene and move throughout the scene in over a full 360-degree range of motion. For example, multiple cameras may be used to capture a sports game and end users can move throughout the re-created field of play freely. For example, the end user may also view the game from a virtual camera.

### BRIEF DESCRIPTION OF THE DRAWINGS

FIG. 1 is a block diagram of an exemplary system for player and ball tracking post processing;

FIG. 2A is an illustration of a complete player trajectory on a field of play;

FIG. 2B is an illustration of an incomplete player trajectory on a field of play;

FIG. 3 is an illustration of trajectories;

FIG. 4 is an illustration of ball trajectory in three axes;

FIG. 5 is an illustration of a quadratic Bezier process for ball trajectory;

FIG. 6 shows the processed trajectory with quadratic Bezier method;

FIG. 7 is a block diagram illustrating a game status detector;

FIG. 8 is a comparison with/without game status module;

FIG. 9 is an illustration of a region of interest of a player;

FIG. 10 is a process flow diagram of a method for player and ball tracking post processing;

FIG. 11 is a block diagram is illustrating player and ball tracking post processing; and

FIG. 12 is a block diagram showing computer readable media 1200 that stores code for player and ball tracking post processing.

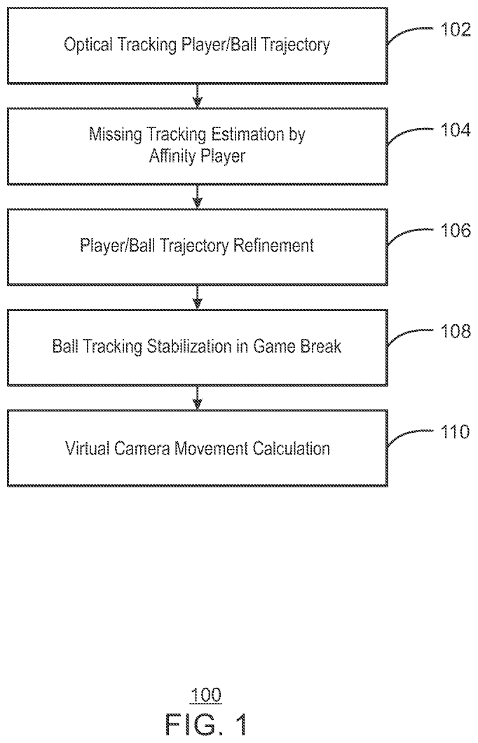

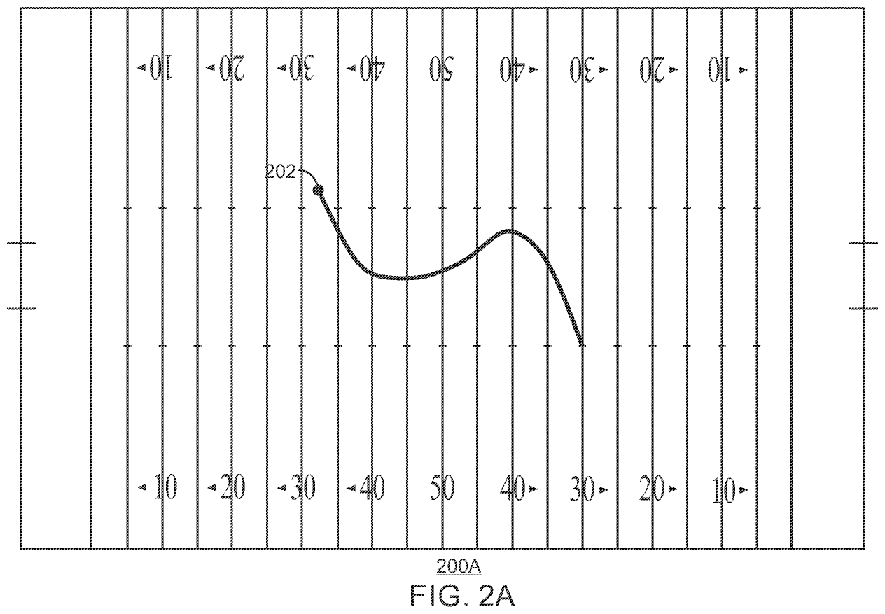

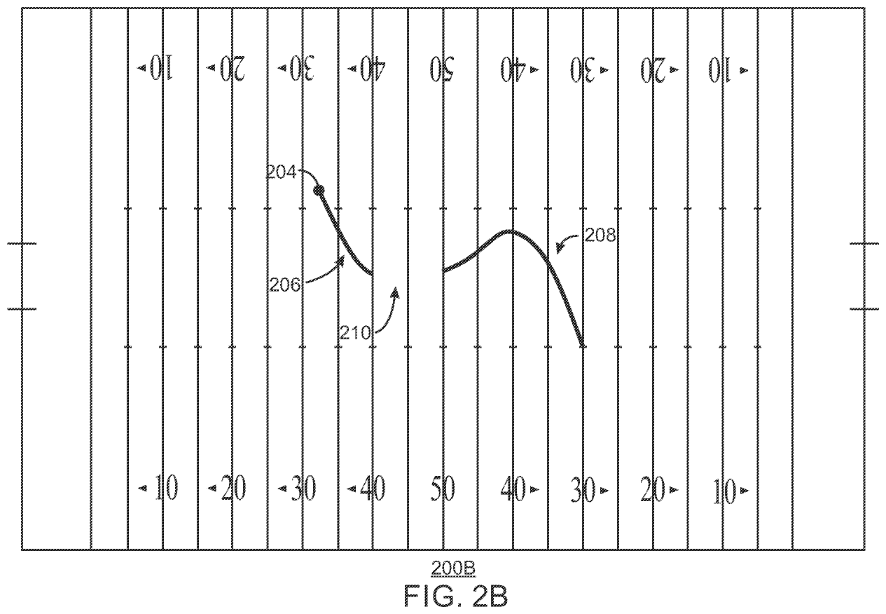

The same numbers are used throughout the disclosure and the figures to reference like components and features. Numbers in the 100 series refer to features originally found in FIG. 1; numbers in the 200 series refer to features originally found in FIG. 2A or FIG. 2B; and so on.

### DESCRIPTION OF THE EMBODIMENTS

Sporting events and other competitions are often broadcast for the entertainment of end users. These games may be rendered in a variety of formats. For example, a game can be rendered as a two-dimensional video or a three-dimensional video. The games may be captured using one or more high-resolution cameras positioned around an entire field of play. The plurality of cameras may capture an entire three-dimensional volumetric space, including the field of play. In embodiments, the camera system may include multiple super high-resolution cameras for volumetric capture. The end users can view the action of the game and move through the captured volume freely by being presented with a sequence of images representing the three-dimensional volumetric space. Additionally, an end user can view the game from a virtual camera that follows the action within the field by following the ball or a specific player in the three-dimensional volumetric space.

In embodiments, a camera system used for volumetric capture may include one or more physical cameras with 5120×3072 resolution, configured throughout a stadium to capture the field of play. For example, the number of cameras in the camera system may be thirty-eight. A subset of cameras may be selected, such as eighteen cameras from among the thirty-eight cameras, to cover the entire field of play and ensure that each pixel in the field of play is captured by at least three cameras. The camera system may capture a real-time video stream from a plurality of cameras. The plurality of cameras may capture the field of play at 30 frames per second (fps). The subset of cameras selected may be different in different scenarios. For example, depending on the structure surrounding the field of play, each location may be captured by at least three cameras using a varying number of cameras.

For ease of description the present techniques are described by referencing an American football game. In the example of an American football game, thirty-eight cameras may be located throughout a stadium to capture volumetric content. Segmentation and three-dimensional (3D) reconstruction may be applied to the captured content to build a 3D scene (e.g., voxel) for every frame. An optical tracking algorithm may be applied to track the ball and each player automatically on the playfield. As used herein, optical tracking data may be trajectories or other movement paths generated according to the visible trajectories or movement paths as captured by one or more cameras of the system. The optical tracking data may be generated to control the movement of a virtual camera. In embodiments, the virtual camera can follow a specific object such as a ball or player of interest to present an immersive viewing experience.

The present techniques enable player and ball trajectory post-processing. For example, the present techniques include a player and/or ball post-processing method that optimizes received player and/or ball trajectories for high quality immersive volumetric video generation. In embodiments, affinity player tracking is implemented to estimate the target player's position by leveraging the information from surrounding players. In examples, affinity player tracking may be implemented when portions or the target player's trajectory is missing or otherwise incomplete. The present techniques can recover the missing portions of the target player's trajectory in a huddle situation. Additionally, the present techniques use a dynamic buffer based on a quadratic Bezier filtering method by using all positions as Bezier control points. The ball/player trajectory is efficiently smoothed without a large position discrepancy as compared to conventional approaches. The present techniques also include game status detection to automatically classify the game as being in one or more states of play. The states of play may be used to stabilize the movement of ball tracking during game breaks. The present techniques provide high quality virtual camera movement without broken or missing trajectory data. The post-processing provided by the present techniques enables an immersive media experience by following the ball or player. The present techniques can significantly improve accuracy of a virtual camera.

As used herein, a game may refer to a form of play according to a set of rules. The game may be played for recreation, entertainment, or achievement. A competitive game may be referred to as a sport, sporting event, or competition. Accordingly, a sport may also be a form of competitive physical activity. The game may have an audience of spectators that observe the game. The spectators may be referred to as end-users when the spectators observe the game via an electronic device, as opposed to viewing the game live and in person. The game may be competitive in nature and organized such that opposing individuals or teams compete to win. A win refers to a first individual or first team being recognized as triumphing over other individuals or teams. A win may also result in an individual or team meeting or securing an achievement. Often, the game is played on a field, court, within an arena, or some other area designated for gameplay. The area designated for gameplay typically includes markings, goal posts, nets, and the like to facilitate gameplay.

A game may be organized as any number of individuals configured in an opposing fashion and competing to win. A team sport is a game where a plurality of individuals is organized into opposing teams. The individuals may be generally referred to as players. The opposing teams may compete to win. Often, the competition includes each player making a strategic movement to successfully overcome one or more players to meet a game objective. An example of a team sport is football.

Generally, football describes a family of games where a ball is kicked at various times to ultimately score a goal. Football may include, for example, association football, gridiron football, rugby football. American football may be a variation of gridiron football. In embodiments, the American football described herein may be as played according to the rules and regulations of the National Football League (NFL). While American football is described, the present techniques may apply to any event where an individual makes strategic movements within a defined space. In embodiments, a strategic movement may be referred to as a trajectory. An end user can be immersed in a rendering of the event based on this trajectory according to the techniques described herein. In particular, the present techniques enable trajectory refinement, which is based on the identification of affinity players with respect to a target player. Again, for ease of description, the present techniques are described using an American football game as an example. However, any game, sport, sporting event, or competition may be used according to the present techniques.

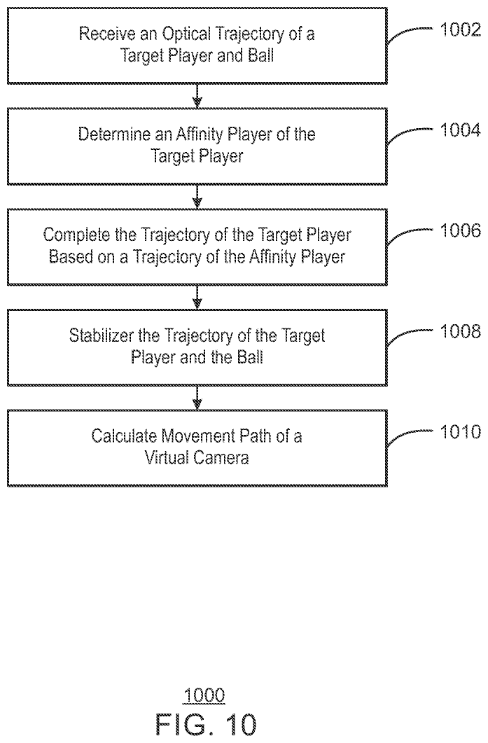

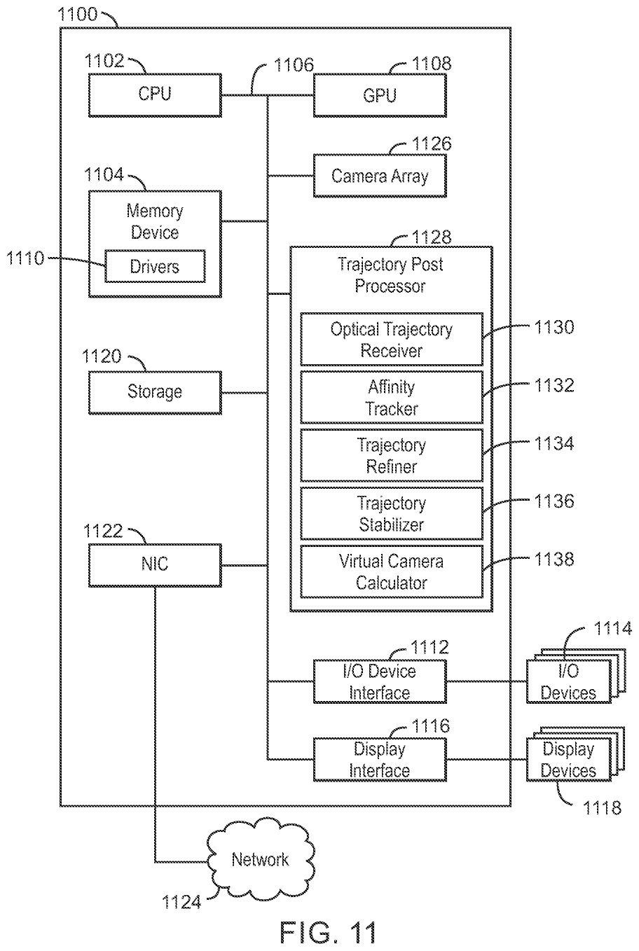

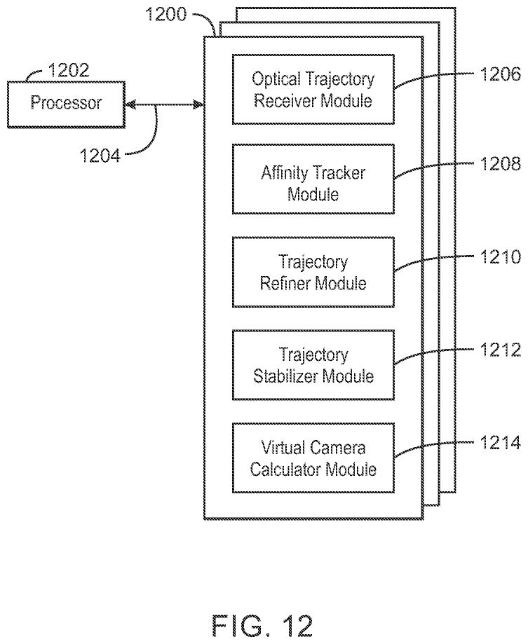

FIG. 1 is a block diagram of an exemplary system 100 for player and ball tracking post processing. The exemplary system 100 can be implemented according to the method 1000 of FIG. 10, or executed at the computing device 1100 of FIG. 11 or the computer readable medium 1200 of FIG. 12.

High precision player and ball tacking are crucial to generate high quality and smooth volumetric video. However, due to the complexity of American football, optical tracking is inaccurate due to large huddles, occlusion, lighting, etc. These issues with optical tracking cause a player to not be visible in one or more camera views. As a result, with optical tracking the object trajectory, such as a player or ball, will be lost or wrong. The missing/wrong player and ball path will lead to non-contiguous or abnormal virtual camera movement which significantly impacts the user experience if the virtual camera doesn't follow the player or ball in real practice.

For example, FIG. 2A is an illustration of a complete player trajectory 202, while FIG. 2B is an illustration of an incomplete player trajectory 204. In FIG. 2A, the target player may disappear in camera views used to calculate the target player's trajectory. This results in missing portions of the players trajectory. In addition to player/ball tracking loss, trajectories may be incomplete due to ball/player sudden acceleration and stop. In some cases, sudden acceleration and stop by a player may cause optical trajectories that are not smooth and contain many jittering. These irregular paths will cause a virtual camera based on these trajectories to shake sharply. Additionally, optical tracking may deliver ambiguous results during game breaks, as there will be multiple balls in the field of play. Multiple balls in the field of play may cause ambiguous ball tracking results. It also degrades virtual camera tracking quality.

Referring again to FIG. 1, an exemplary system 100 for player and ball tracking post processing is provided. At block 102, an optical tracker tracks trajectories of a player and a ball. As noted above, optical tracking may suffer from several deficiencies that cause jittery or unsuitable player or ball trajectories. At block 104, an affinity tracker estimates the missing trajectories of the target player of the ball based on the trajectory of an affinity player. As described below, and affinity player is a player that is likely to be near the target player. Typically, when a target player is not visible in a camera view, one or more affinity players are visible in the same camera view. In embodiments, the trajectory of the target player or ball may be refined based on the trajectory of the affinity player. The trajectory of the affinity player may be obtained via optical tracking.

At block 106, trajectory refinement refines the trajectory of the player and the ball. The trajectory may be refined using a quadratic Bezier calculation. At block 108, ball tracking stabilization stabilizes the ball tracking during a game break. At block 110, a virtual camera calculator calculates the movement of a virtual camera.

The diagram of FIG. 1 is not intended to indicate that the example system is to include all of the systems and modules shown in FIG. 1. Rather, the example system 100 can be implemented using fewer or additional camera systems and modules not illustrated in FIG. 1.

FIG. 2A is an illustration of a ground truth player trajectory on a field of play 200A. As illustrated, the trajectory 202 follows the path of a player during game play within the field of play. Generally, the “field of play” may be referred to as a field. The player trajectory is based on the movement of the player. In the football example of FIGS. 2A and 2B, a number of cameras may be used to capture the fields 200A and 200B. Multiple calibrated cameras may be deployed in a stadium to capture high-resolution images of the field fields 200A and 200B. The images may be processed via optical tracking, which may include segmentation. Segmentation includes the extraction of each player from a captured image, and the location of the player in each frame is calculated based on the segment. The present techniques enable a virtual camera to be placed in the 3D space and navigated within 3D space to follow a player or ball. In embodiments, the present techniques also enable a virtual camera to be placed in the 3D space and navigated freely within 3D space, thereby creating a new trajectory within the 3D space.

The operation of the virtual camera may depend on the positions of players or ball, which are typically the focus of the game. In embodiments, the player location and trajectory control or dictate the virtual camera path movement. In embodiments, the player trajectory may provide a path along which a virtual camera may progress through the field of play. The ability to progress through the field of play enables an end user to “see” the same view as a player saw during real-time gameplay.

FIG. 2B is an illustration of an incomplete player trajectory on a field of play 200B. The trajectory 204 follows the same path as the trajectory 202 of FIG. 2A. However, the trajectory 204 is incomplete. In examples, the trajectory 204 may be established using optical tracking. Optical tracking generates a ball and player location for each frame to create a ball and a player trajectory. In embodiments, optical player tracking results include player locations and player identification information. The trajectory 204 has non-contiguous locations 206 and 208, with a missing portion 210 of the trajectory. The missing portions of the trajectories may result in poor virtual camera movement. Traditionally, when the target object (player and ball) is missing for a few seconds, a short time look-ahead buffer (e.g., T seconds) may be used to linearly interpolate the lost trajectory. However, if the lost time is longer than T seconds, the tracking trajectory for the target player or ball is unrecoverable.

The diagram of FIGS. 2A and 2B are not intended to indicate that the exemplary fields 200A and 200B are to include all of the players or field markings shown in FIGS. 2A and 2B. Rather, the example fields can be implemented using fewer or additional players and markings not illustrated in FIGS. 2A and 2B. For example, during active gameplay in American football, each team may have up to eleven players on the field. Players may be freely substituted between downs. Moreover, the present techniques are not limited to the gameplay described above. In some instances, the rules of gameplay may be modified, resulting in a modification of when players are detected and tracked. Additionally, the present techniques enable optical solutions to track each player, including when players are substituted between downs or other breaks in gameplay.

Accurate player tracking and trajectory generation can be a very challenging task in team sports due to the heavy occlusion of players, large variation of player body shapes, and the generally similar appearance of players of the same team. Thus, the present techniques enable optical trajectory refinement based on an identification of affinity players in a field of play, at any frame from any camera using only the data captured by that particular camera. In particular, the present techniques connect a target player to corresponding affinity players, and in the event that the target player is occluded/not visible in a camera view, the visible trajectory of the affinity players are used to estimate the trajectory of the target player.

As used herein, an affinity player is a player that is likely to guard a target player when the target player is on offense. When the target player is on defense, an affinity player is a player that is likely to be guarded by the target player. Typically, it can be found that heavy huddle/occlusion is the major reason why the target player's position is correct. However, the jersey or other identifying information cannot be detected due to occlusion. As the target player is occluded by at least 1-2 surrounded players, they can be treated as a bundle that generally moves in the same direction. These surrounding players largely represent the behavior of the missing, invisible target player. These surrounding players are affinity players. In examples, the target player and affinity players are from the opposite team. Typically, in case of huddle/occlusion, the target player and affinity players have close body contact and run in the same direction.

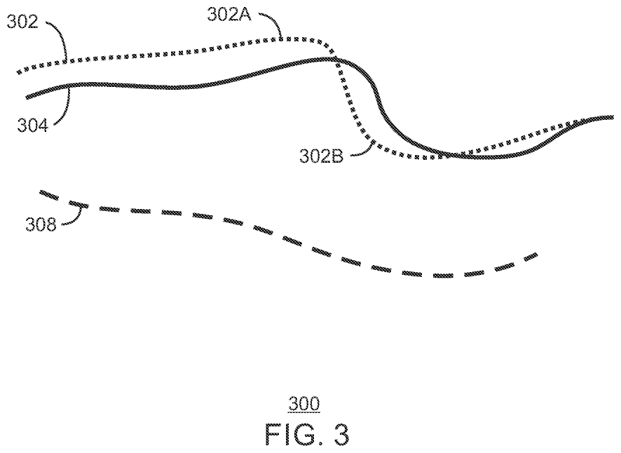

FIG. 3 is an illustration of trajectories 300. The present techniques use affinity player tracking to estimate a missing target player trajectory. At the start of game play, one or more affinity players within a pre-defined distance of the target player are identified. Affinity players may be identified continuously throughout game play. In embodiments, affinity players may also be identified according to the particular offensive/defensive position of the affinity player and its relationship to the offensive/defensive position of the target player. For example, in American football, if the target player is a wide receiver, a cornerback on the same side of the field may be identified as an affinity player with respect to the wide receiver. Additionally, a safety on the same side of the field may also be identified as an affinity player when the target player is a wide receiver.

When the target player is no longer visible in optical tracking or otherwise unidentifiable, a mean location of the identified affinity players is used to estimate the location of the player. These estimated locations are used to derive or refine the missing or jittery portions trajectory of the target player. As illustrated in FIG. 3, trajectory 302 is a trajectory of a target player. The trajectory 302 includes segments 302A and 302B. Trajectory 304 is a trajectory of an affinity player 304. Trajectory 306 is a trajectory of another player. As illustrated, for a particular camera view the trajectory 302 of the target player may be incomplete due to occlusion of the target player. Thus, the segment 302B of the trajectory 302 may not be tracked using optical tracking. However, at a point of occlusion 308, the trajectory 304 closely matches the segment 302B trajectory 302. The trajectory 304 can be used to estimate the segment 302B, which may be lost due to occlusion. Therefore, affinity player's trajectory gives a very close estimation for the target player. Our system can continue to track until the target player recovers in normal optical player tracking.

As described above, player/ball path jittering as calculated using optical tracking techniques may degrade the calculated trajectory, and ultimately yield poor virtual camera movement. Accordingly, player/ball path jittering is another important factor—which leads to a poor virtual camera movement experience. It causes volumetric video shaking due to non-smooth camera motion. Traditionally, a mean or quadric filter is applied to trajectories to smooth the trajectory. In these traditional solutions, the smoothness of the resulting trajectory is dependent on a length of a buffer. In particular, if the buffer is too long, the processed position would be far from the original one. If the buffer is too short, the refined position would not be smooth as expected.

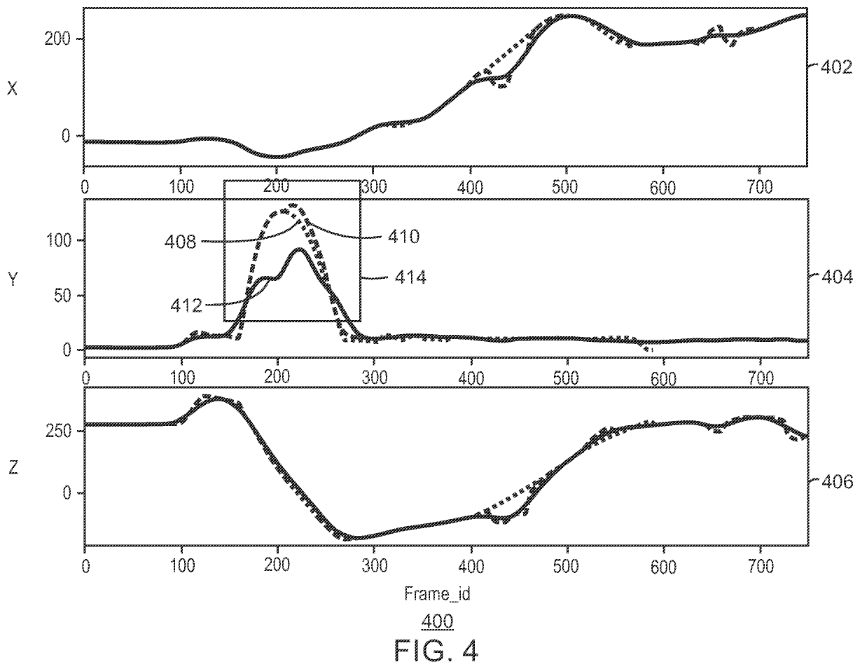

FIG. 4 is an illustration of a ball trajectory along three axes processed with quadratic interpolation. In the example of FIG. 4, the ball path is used as an example. The ball path is illustrated in the z-y plane at trajectory 402, x-z plane at trajectory 404, and the x-y plane at trajectory 406. The x-z plane represents the ground plane. In the x-z plane, the trajectory 404 illustrated y as the height where jitter occurs and 30 frames can be used to smooth the trajectory. The dashed line 408 represents the ground truth, the longer dashed line 410 represents optical tracking output, and the solid line 412 is the smoothed result using traditional quadric interpolation. Though the quadric interpolation generates smoother results, it incurs large deviation compared to the ground truth as shown in the box 414. During this period, the ball falls down quickly and quadric filtering accurately process a sharp ball path change.

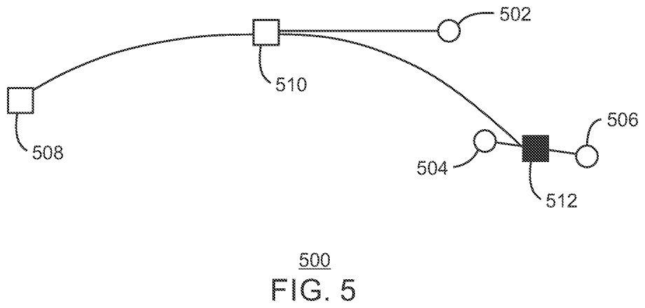

FIG. 5 is an illustration of a quadratic Bezier process for ball trajectory. To overcome the inaccurate quadratic interpolation due to fast ball movement, the present techniques use a quadratic Bezier curve to smooth trajectory with a dynamic frame buffer window. In embodiments, the ball locations are considered along every sampling trajectory as control points in the quadratic Bezier curve. The buffer window size is adjusted depending on the ball's moving speed. The quadratic Bezier interpolation is calculated to generate smooth ball moving path. In FIG. 5, the ball locations are represented by circles 502, 504, and 506. The ball locations 502, 504, and 506 are used as the control points of Bezier curve. The squares 508, 501, and 512 interpolated positions calculated by the quadratic Bezier method.

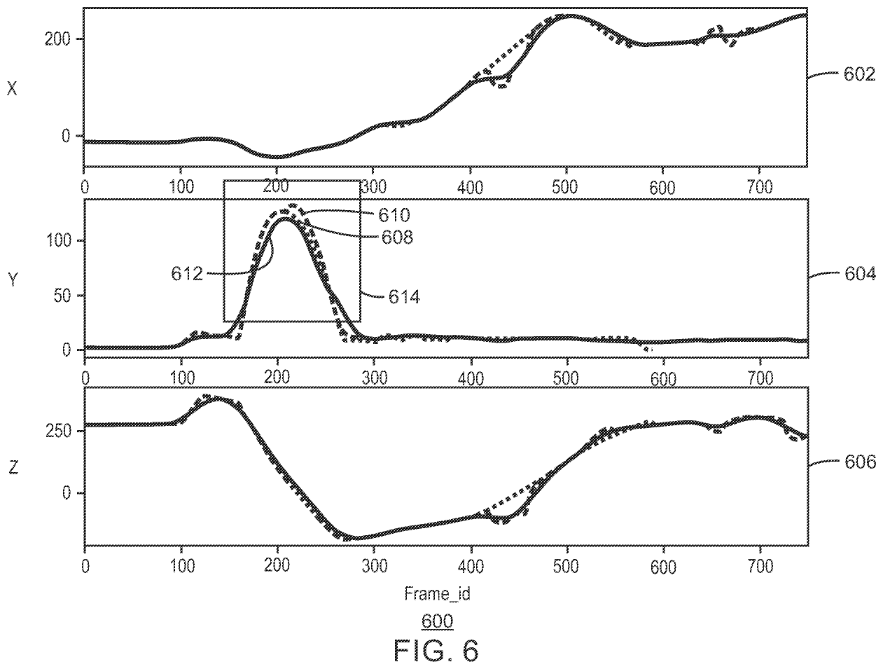

FIG. 6 is an illustration of a ball trajectory along three axes processed using a quadratic Bezier curve. The ball path is illustrated in the z-y plane at trajectory 602, x-z plane at trajectory 604, and the x-y plane at trajectory 606. The x-z plane represents the ground plane. In the x-z plane, the trajectory 604 illustrated y as the height where jitter occurs and 30 frames can be used to smooth the trajectory. The dashed line 608 represents the ground truth, the longer dashed line 610 represents optical tracking output, and the solid line 612 is the smoothed results using the quadratic Bezier processed trajectory. The final smoothed output is very close to the raw optical tracking output in position, and it works well even in the ball falling down stage as shown in the box 611.

In addition to smoothing the ball and player trajectories, the ball tracking may be stabilized to ensure accurate virtual camera tracking with respect to the ball. For example, at several times in an American football gamer, breaks occur and more than one ball is present within the field of play. When more than one ball is present within a field of play, unexpected virtual camera movement may occur in an attempt to follow the ball. The present techniques provide game status detection to determine various states of an event, such as an American football game. The various states may be used to stabilize ball tracking during game breaks or other situations where multiple balls are present.

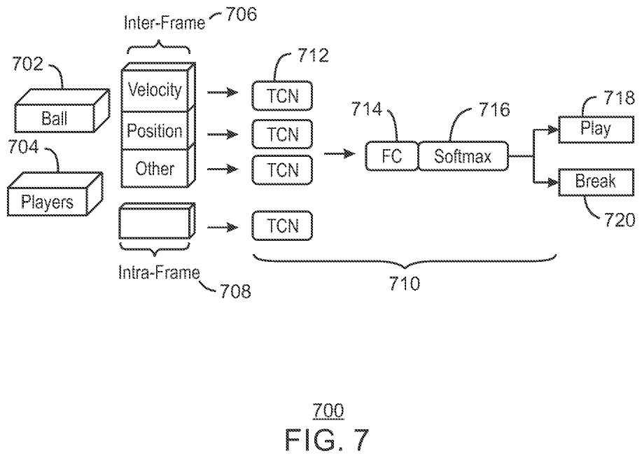

FIG. 7 is a block diagram illustrating a game status detector 700. In FIG. 7, the ball is represented at block 702 and players are represented at block 704. For each of the ball 702 and players 704, inter-frame data 706 and intra-frame data 708 are provided to a temporal convolution network 710. Generally, in an American football game, there are three states of the game: 1) line setting, 2) attack & defend action, and 3) game break. Line setting may generally be referred to as the start of a play. In American football, this typically occurs within 40 seconds from the end of the previously play. Attack and defend action refers to the time during a play of an American football game. A break or game break refers to timeouts or other official stoppages of game play.

A current state, also referred to as a game state or status, can be estimated according to the velocity information from the ball and player trajectories. In embodiments, inter-frame information 706 includes velocity, position, and other data such as orientation for the ball 702 and the players 704. The temporal convolutional network (TCN) 710 is used to determine the game status with a look-ahead buffer. In embodiments, the TCN outputs a state every 10 frames. The TCN 710 includes a plurality of temporal convolution layers 712, a fully connected layer 714, and a SoftMax function 716. In the example of FIG. 7, the states include a play 718 or a game break 720. Accordingly, in the architecture of game status detector illustrated in FIG. 7 velocity, position and other indicator (such as orientation) of player and ball are sent to a temporal convolution network 710, then temporal convolution network 710 will output the game status, such as a game state that include a play or break.

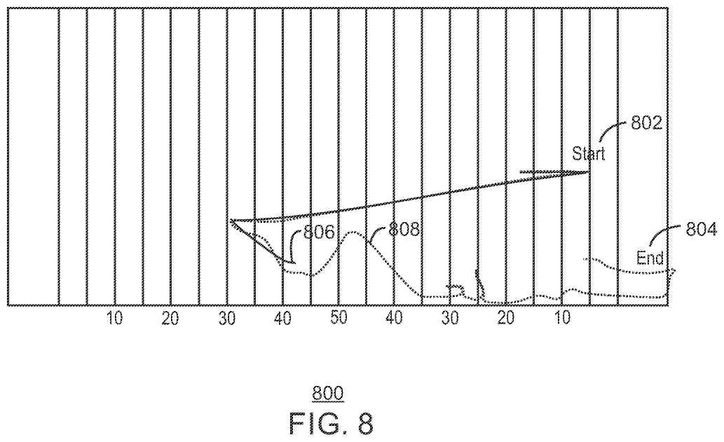

In embodiments, ball position is stabilized as described with respect to FIGS. 4-6 during a game break. In particular, during a game break, the virtual camera position is fixed to stabilize the camera until a new play begins. FIG. 8 is a comparison of trajectories. In particular, in FIG. 8 a trajectory 806 with game status detection and a trajectory 808 without game status detection are illustrated. The virtual camera movement based on the trajectory 806 stops during game breaks. Thus, the trajectory 806 is shorter than the trajectory 808. However, without game status detection, the ball tracking algorithm continues outputting ball trajectory 808. If virtual camera follows the trajectory 808, shaking, jitter, and other undesirable effects may occur due to several balls on the field.

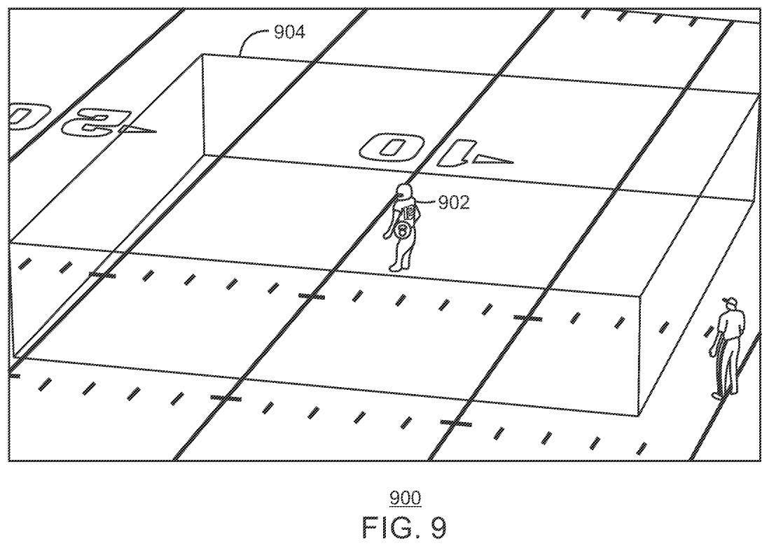

FIG. 9 is an illustration of a region of interest of a player. After restoring and refining the optical tracking of the player and ball, a virtual camera focus area may be calculated by determining a three-dimensional (3D) region of interest (ROI) 904 shown in FIG. 9. The ROI 904 contains the target player 902. Then 3D ROI stream is transmitted to a camera engine and to calculate camera orientation, camera position and zoom-in, zoom-out parameters to generate final volumetric video with 3D point clouds.

In this manner, the present techniques enable a smooth and seamless way to track a player and ball position virtually. In an exemplary virtual camera simulator to use to simulate “follow ball” and “follow player” feature, after applying the post-processing methods described herein, the error rate of ball tracking is reduced from 6% to 2%, and player tracking error rate is reduced from 4% to 1.6%. It greatly improves the capability of virtual camera to keep track of the ball and player of interest.

FIG. 10 is a process flow diagram of a method 1000 for player and ball tracking post processing. The method 1000 may be implemented by the according to the system 100 of FIG. 1, or executed at the computing device 1100 of FIG. 11 or the computer readable medium 1200 of FIG. 12. At block 1002, an optical trajectory of a target player or ball is received. At block 1004, at least one affinity player of a target player is determined. At block 1006, the optical trajectory of the target player is completed based on a trajectory of an affinity player. At block 1008, the optical trajectory of the ball and complete trajectory of the target player are stabilized. At block 1010, a movement path for a virtual camera is calculated to generate a final volumetric video.

Accordingly, the present techniques enable an estimation of missing tracking by affinity player. The present techniques also enable a refinement of player and object trajectory by using a quadratic Bezier of a dynamic sliding window across points of the trajectory. The number of points used within the sliding window may change as necessary. Further, the present techniques enable stabilization of a virtual camera by game status detection. With these new features, we can create high quality virtual camera movement for compelling immersive media.

This process flow diagram is not intended to indicate that the blocks of the example process of method 1000 is to be executed in any particular order, or that all of the blocks are to be included in every case. Further, any number of additional blocks not shown may be included within the method 1000, depending on the details of the specific implementation.

Referring now to FIG. 11, a block diagram is shown illustrating player and ball tracking post processing. The computing device 1100 may be, for example, a laptop computer, desktop computer, tablet computer, mobile device, or wearable device, among others. In some examples, the computing device 1100 may be a smart camera or a digital security surveillance camera. The computing device 1100 may include a central processing unit (CPU) 1102 that is configured to execute stored instructions, as well as a memory device 1104 that stores instructions that are executable by the CPU 1102. The CPU 1102 may be coupled to the memory device 1104 by a bus 1106. Additionally, the CPU 1102 can be a single core processor, a multi-core processor, a computing cluster, or any number of other configurations. Furthermore, the computing device 1100 may include more than one CPU 1102. In some examples, the CPU 1102 may be a system-on-chip (SoC) with a multi-core processor architecture. In some examples, the CPU 1102 can be a specialized digital signal processor (DSP) used for image processing. The memory device 1104 can include random access memory (RAM), read only memory (ROM), flash memory, or any other suitable memory systems. For example, the memory device 1104 may include dynamic random-access memory (DRAM).

The computing device 1100 may also include a graphics processing unit (GPU) 1108. As shown, the CPU 1102 may be coupled through the bus 1106 to the GPU 1108. The GPU 1108 may be configured to perform any number of graphics operations within the computing device 1100. For example, the GPU 1108 may be configured to render or manipulate graphics images, graphics frames, videos, or the like, to be displayed to a viewer of the computing device 1100.

The CPU 1102 may also be connected through the bus 1106 to an input/output (I/O) device interface 1110 configured to connect the computing device 1100 to one or more I/O devices 1112. The I/O devices 1112 may include, for example, a keyboard and a pointing device, wherein the pointing device may include a touchpad or a touchscreen, among others. The I/O devices 1112 may be built-in components of the computing device 1100, or may be devices that are externally connected to the computing device 1100. In some examples, the memory 1104 may be communicatively coupled to I/O devices 1112 through direct memory access (DMA).

The CPU 1102 may also be linked through the bus 1106 to a display interface 1116 configured to connect the computing device 1100 to a display device 1118. The display devices 1116 may include a display screen that is a built-in component of the computing device 1100. The display devices 1118 may also include a computer monitor, television, or projector, among others, that is internal to or externally connected to the computing device 1100. The display device 1118 may also include a head mounted display.

The computing device 1100 also includes a storage device 1120. The storage device 1120 is a physical memory such as a hard drive, an optical drive, a thumbdrive, an array of drives, a solid-state drive, or any combinations thereof. The storage device 1120 may also include remote storage drives.

The computing device 1100 may also include a network interface controller (NIC) 1122. The NIC 1122 may be configured to connect the computing device 1100 through the bus 1106 to a network 1124. The network 1124 may be a wide area network (WAN), local area network (LAN), or the Internet, among others. In some examples, the device may communicate with other devices through a wireless technology. For example, the device may communicate with other devices via a wireless local area network connection. In some examples, the device may connect and communicate with other devices via Bluetooth® or similar technology.

The computing device 1100 further includes camera 1126. Although the camera is illustrated as included in the computing device 1100, the camera array may be remotely located from the computing device 1100 and the computing device 1100 may be communicatively coupled with the camera array 1126. In the example of an American football game, the camera array 1126 may be disposed around the field of play.

Additionally, the computing device 1100 includes a trajectory post-processor 1128. The trajectory post-processor 1128 may be configured to enable a 360° view of a sporting event from any angle. In particular, ball and player trajectories generated may be processed such that an end user can virtually experience any location within the field of play. In particular, the end user may establish a viewpoint in the game, regardless of particular camera locations used to capture images of the sporting event. The trajectory post-processor 1128 includes an optical tracker receiver 1130 to determine an optical track of a target player and a ball. An affinity tracker 1132 is to estimate the missing portions of the target player trajectory or ball trajectory based on the trajectory of an affinity player. A trajectory refiner 1134 is to refine the trajectory of the player and ball via a quadratic Bezier function. A ball trajectory stabilizer 1136 is to stabilize the trajectory of the ball. A virtual camera calculator 1138 calculates the movement of a virtual camera based on the target player and ball trajectories.

The block diagram of FIG. 11 is not intended to indicate that the computing device 1100 is to include all of the components shown in FIG. 11. Rather, the computing device 1100 can include fewer or additional components not illustrated in FIG. 11, such as additional buffers, additional processors, and the like. The computing device 1100 may include any number of additional components not shown in FIG. 11, depending on the details of the specific implementation. Furthermore, any of the functionalities of the trajectory post-processor 1128, optical tracker receiver 1130, affinity tracker 1132, trajectory refiner 1134, ball trajectory stabilizer 1136, and virtual camera calculator 1138 may be partially, or entirely, implemented in hardware and/or in the processor 1102. For example, the functionality may be implemented with an application specific integrated circuit, in logic implemented in the processor 1102, or in any other device. For example, the functionality of the trajectory post-processor 1128 may be implemented with an application specific integrated circuit, in logic implemented in a processor, in logic implemented in a specialized graphics processing unit such as the GPU 1108, or in any other device.

FIG. 12 is a block diagram showing computer readable media 1200 that stores code for player and ball tracking post processing. The computer readable media 1200 may be accessed by a processor 1202 over a computer bus 1204. Furthermore, the computer readable medium 1200 may include code configured to direct the processor 1202 to perform the methods described herein. In some embodiments, the computer readable media 1200 may be non-transitory computer readable media. In some examples, the computer readable media 1200 may be storage media.

The various software components discussed herein may be stored on one or more computer readable media 1200, as indicated in FIG. 12. For example, an optical tracker receiver module 1206 is configured to determine an optical track of a target player and a ball. An affinity tracker module 1208 is configured to estimate the missing portions of the target player trajectory or ball trajectory based on the trajectory of an affinity player. A trajectory refiner module 1210 is configured to refine the trajectory of the player and ball via a quadratic Bezier function. A ball trajectory stabilizer module 1212 is configured to stabilize the trajectory of the ball. A virtual camera calculator module 1214 is configured to calculate the movement of a virtual camera based on the target player and ball trajectories.

The block diagram of FIG. 12 is not intended to indicate that the computer readable media 1200 is to include all of the components shown in FIG. 12. Further, the computer readable media 1200 may include any number of additional components not shown in FIG. 12, depending on the details of the specific implementation.

### EXAMPLES

Example 1 is a method for player and ball tracking post processing. The method includes optically tracking a trajectory of a player and ball and determining at least one affinity player for the currently tracked player. The method also includes completing the optical trajectory for the currently tracked player based on an estimated trajectory from the affinity player, stabilizing ball tracking during game break, and calculating virtual camera movement.

Example 2 includes the method of example 1, including or excluding optional features. In this example, the affinity player is from the opposing team.

Example 3 includes the method of any one of examples 1 to 2, including or excluding optional features. In this example, the method includes selecting a plurality of affinity players, wherein a mean location of the affinity players is used to derive the location of the current player.

Example 4 includes the method of any one of examples 1 to 3, including or excluding optional features. In this example, the affinity player location is used to determine the missing trajectory of the current player until the current player is recovered in normal optical tracking.

Example 5 includes the method of any one of examples 1 to 4, including or excluding optional features. In this example, refining the trajectory comprises using a quadratic Bezier curve to smooth the trajectory.

Example 6 includes the method of any one of examples 1 to 5, including or excluding optional features. In this example, stabilizing the ball tracking comprises determining a game break and stabilizing the ball trajectory during game break.

Example 7 includes the method of any one of examples 1 to 6, including or excluding optional features. In this example, stabilizing the ball tacking the virtual camera is fixed to reset for a new play.

Example 8 includes the method of any one of examples 1 to 7, including or excluding optional features. In this example, the virtual camera focus area is calculated by determining a 3D region of interest (the temporal association is found by determining a bounding box including the first player in multiple frames of a same camera view of the captured field of view.)

Example 9 includes the method of any one of examples 1 to 8, including or excluding optional features. In this example, the method includes constructing a virtual camera within a three-dimensional volumetric representation of the captured field of view, and progressing through the three-dimensional volumetric representation according to the generated trajectory.

Example 10 is a system for trajectory generation based on player tracking. The system includes an optical trajectory receiver to receive an optical trajectory of a player and a ball, an affinity tracker to determine at least one affinity player for the currently tracked player, and a trajectory refiner to complete the optical trajectory for the currently tracked player based on an estimated trajectory from the affinity player. The system further includes a trajectory stabilizer to stabilize ball tracking during game break and a virtual camera calculator to calculate virtual camera movement.

Example 11 includes the system of example 10, including or excluding optional features. In this example, the affinity player is from the opposing team.

Example 12 includes the system of any one of examples 10 to 11, including or excluding optional features. In this example, the system includes selecting a plurality of affinity players, wherein a mean location of the affinity players is used to derive the location of the current player.

Example 13 includes the system of any one of examples 10 to 12, including or excluding optional features. In this example, the affinity player location is used to determine the missing trajectory of the current player until the current player is recovered in normal optical tracking.

Example 14 includes the system of any one of examples 10 to 13, including or excluding optional features. In this example, refining the trajectory comprises using a quadratic Bezier curve to smooth the trajectory.

Example 15 includes the system of any one of examples 10 to 14, including or excluding optional features. In this example, stabilizing the ball tracking comprises determining a game break and stabilizing the ball trajectory during game break.

Example 16 includes the system of any one of examples 10 to 15, including or excluding optional features. In this example, stabilizing the ball tacking the virtual camera is fixed to reset for a new play.

Example 17 includes the system of any one of examples 10 to 16, including or excluding optional features. In this example, the virtual camera focus area is calculated by determining a 3D region of interest (the temporal association is found by determining a bounding box including the first player in multiple frames of a same camera view of the captured field of view.)

Example 18 includes the system of any one of examples 10 to 17, including or excluding optional features. In this example, the system includes constructing a virtual camera within a three-dimensional volumetric representation of the captured field of view, and progressing through the three-dimensional volumetric representation according to the generated trajectory.

Example 19 is at least one non-transitory computer-readable medium. The computer-readable medium includes instructions that direct the processor to optically track a trajectory of a player and ball and determine at least one affinity player for the currently tracked player. The computer-readable medium also includes instructions that direct the processor to complete the optical trajectory for the currently tracked player based on an estimated trajectory from the affinity player, stabilize ball tracking during game break, and calculate virtual camera movement.

Example 20 includes the computer-readable medium of example 19, including or excluding optional features. In this example, the affinity player is from the opposing team.

Example 21 includes the computer-readable medium of any one of examples 19 to 20, including or excluding optional features. In this example, the computer-readable medium includes selecting a plurality of affinity players, wherein a mean location of the affinity players is used to derive the location of the current player.

Example 22 includes the computer-readable medium of any one of examples 19 to 21, including or excluding optional features. In this example, the affinity player location is used to determine the missing trajectory of the current player until the current player is recovered in normal optical tracking.

Example 23 includes the computer-readable medium of any one of examples 19 to 22, including or excluding optional features. In this example, refining the trajectory comprises using a quadratic Bezier curve to smooth the trajectory.

Example 24 includes the computer-readable medium of any one of examples 19 to 23, including or excluding optional features. In this example, stabilizing the ball tracking comprises determining a game break and stabilizing the ball trajectory during game break.

Example 25 includes the computer-readable medium of any one of examples 19 to 24, including or excluding optional features. In this example, stabilizing the ball tacking the virtual camera is fixed to reset for a new play.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more aspects. For instance, all optional features of the computing device described above may also be implemented with respect to either of the methods or the computer-readable medium described herein. Furthermore, although flow diagrams and/or state diagrams may have been used herein to describe aspects, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1. A method for player and ball tracking post processing, the method comprising:
optically tracking a trajectory of a player and a ball;
determining at least one affinity player for the currently tracked player;
completing the optical trajectory for the currently tracked player based on an estimated trajectory from the affinity player;
stabilizing ball tracking during game break; and
calculating virtual camera movement.

2. The method of claim 1, wherein the affinity player is from the opposing team.

3. The method of claim 1, further including selecting a plurality of affinity players, wherein a mean location of the affinity players is used to derive the location of the current player.

4. The method of claim 1, wherein the affinity player location is used to determine the missing trajectory of the current player until the current player is recovered in normal optical tracking.

5. The method of claim 1, wherein refining the trajectory includes using a quadratic Bezier curve to smooth the trajectory.

6. The method of claim 1, wherein stabilizing the ball tracking includes determining a game break and stabilizing the ball trajectory during the game break.

7. The method of claim 1, wherein stabilizing the ball tracking includes fixing the virtual camera to reset for a new play.

8. The method of claim 1, wherein the virtual camera focus area is calculated by determining a 3D region of interest such that the temporal association is found by determining a bounding box including the first player in multiple frames of a same camera view of the captured field of view.

9. The method of claim 1, further including:
constructing a virtual camera within a three-dimensional volumetric representation of the captured field of view, and
progressing through the three-dimensional volumetric representation according to the generated trajectory.

10. A system for trajectory generation based on player tracking, the system comprising:
an optical trajectory receiver to receive an optical trajectory of a player and a ball;
an affinity tracker to determine at least one affinity player for the currently tracked player;
a trajectory refiner to complete the optical trajectory for the currently tracked player based on an estimated trajectory from the affinity player;
a trajectory stabilizer to stabilize ball tracking during game break; and
a virtual camera calculator to calculate virtual camera movement.

11. The system of claim 10, wherein the affinity player is from the opposing team.

12. The system of claim 10, wherein a plurality of affinity players is selected, and wherein a mean location of the affinity players is used to derive the location of the current player.

13. The system of claim 10, wherein the affinity player location is used to determine the missing trajectory of the current player until the current player is recovered in normal optical tracking.

14. The system of claim 10, wherein refining the trajectory includes using a quadratic Bezier curve to smooth the trajectory.

15. The system of claim 10, wherein the ball tracking is stabilized by determining a game break and stabilizing the ball trajectory during the game break.

16. The system of claim 10, wherein the ball tracking is stabilized by the virtual camera being fixed to reset for a new play.

17. The system of claim 10, wherein the virtual camera focus area is calculated by determining a 3D region of interest such that the temporal association is found by determining a bounding box including the first player in multiple frames of a same camera view of the captured field of view.

18. The system of claim 10, wherein a virtual camera is stabilized within a three-dimensional volumetric representation of the captured field of view, and wherein the virtual camera is moved through the three-dimensional volumetric representation according to the generated trajectory.

19. At least one non-transitory computer-readable medium comprising instructions, which when executed, cause a processor to:
optically track a trajectory of a player and a ball;
determine at least one affinity player for the currently tracked player;
complete the optical trajectory for the currently tracked player based on an estimated trajectory from the affinity player;
stabilize ball tracking during game break; and
calculate virtual camera movement.

20. The computer readable medium of claim 19, wherein the affinity player is from the opposing team.

21. The computer readable medium of claim 19, wherein the instructions cause the processor to select a plurality of affinity players, wherein a mean location of the affinity players is used to derive the location of the current player.

22. The computer readable medium of claim 19, wherein the affinity player location is used to determine the missing trajectory of the current player until the current player is recovered in normal optical tracking.

23. The computer readable medium of claim 19, wherein the trajectory is refined using a quadratic Bezier curve to smooth the trajectory.

24. The computer readable medium of claim 19, wherein the ball tracking is stabilized by determining a game break and stabilizing the ball trajectory during the game break.

25. The computer readable medium of claim 19, wherein the ball tracking is stabilized by fixing the virtual camera to reset for a new play.
